(19) United States
(12) Patent Application Publication
(10) Pub. No.: US 2004/0167800 A1
(43) Pub. Date: Aug. 26, 2004

(54) Methods and systems for searching, displaying, and managing medical teaching cases in a medical teaching case database

(75) Inventors: Christopher Y. Chang, Durham, NC (US); Gregory F. Hulka, Hillsborough, NC (US); Susan M. Kansagra, Durham, NC (US); Linda G. Leithe, Raleigh, NC (US)

Correspondence Address: JENKINS & WILSON, PA, 3100 TOWER BLVD, SUITE 1400, DURHAM, NC, 27707, US

(73) Assignee: Duke University

(21) Appl. No.: 10/374,945

(22) Filed: Feb. 26, 2003

(51) Int. Cl. G06F 17/60

(52) U.S. Cl. 705/2

(57) ABSTRACT

Methods and Systems for Searching, Displaying and Managing Medical Teaching Cases in a Medical Teaching Case Database. A method is provided for displaying relevant medical teaching cases in a medical teaching case database. The method can include providing a medical teaching case database comprising medical teaching cases including medical case text and image information. The method can also include one or more of the following steps: entering search criteria for relevant medical teaching cases in the medical teaching case database; searching the medical teaching case database based on the search criteria for identifying relevant medical teaching cases; and displaying at least a portion of the text or image information of at least one of the relevant medical teaching cases.

### TECHNICAL FIELD

The present invention relates to medical case systems and methods. Specifically, the present invention relates to systems and methods for searching, displaying, and managing medical teaching cases of a medical teaching case database.

### BACKGROUND ART

Traditional medical education methods include the study of medical case histories contained in medical case collections for illustrating patient condition, diagnosis, disease, and treatment. Medical educators can collect and present medical case collections in lectures, textbooks, and conferences for training students, residents, physicians, or other allied health professionals. Medical cases for educational purposes are typically compiled from the cases of attending physicians or other educators having training responsibilities.

Therefore, the various medical case collections typically focus on the particular specialty area of the attending physician or educator.

Recently, some medical case collections have been stored in computer databases. In general, computer databases include a data structure of data fields and records for organizing a collection of related information. A data field can contain a single piece of data, such as text information, or provide a link to data containing text information. A record is a complete set of data fields. Database applications and programs can be implemented on a computer for modifying, extracting, and displaying the information contained in the database. Databases can be organized in a searchable table or searched based on entered search criteria for locating a record of interest.

Some current medical teaching case databases include photographs or radiology films collected together based on a unique, classic or unusual patient presentation for a given pathology. However, these databases do not provide a complete medical case history of a patient. For example, current medical teaching case databases lack information relating to important text information such as medical case history, diagnosis, classification, physical examination, treatment, educational points, lab results, surgical/medical findings and approach. Additionally, some current medical teaching case databases are searchable based on only one search criteria or organized only by index or table of contents.

Current medical teaching case databases can only store a few categories of pertinent text information of a medical case. Therefore, the current medical teaching case databases do not provide for storing the complete image, historical, or other text information contained in a medical case. Medical education would benefit by having available a searchable medical teaching case database having complete medical case information, including the complete image and text information. Furthermore, the medical teaching case database may be used by practicing health professionals to assist in diagnosing a puzzling patient presentation. In these situations, various diagnostic case examples may be generated from the database to compare with a given patient history and associated physical and radiological findings. Thus, medical teaching case databases are desired having fields for containing all of the pertinent image and text information of a medical case.

Medical education would benefit by having tools to search the medical teaching case database by entering more than one search criteria for search of the various fields of the medical teaching case database. Thus, it is desired to provide an efficiently searchable medical teaching case database for conveniently searching, displaying, and managing the image and text information of relevant medical teaching cases.

### DISCLOSURE OF THE INVENTION

According to one embodiment of the present invention, a method for displaying relevant medical teaching cases in a medical teaching case database is provided. The method can include a step for providing a medical teaching case database comprising medical teaching cases including medical case text and image information. The method can also include one or more of the following steps: entering search criteria for relevant medical teaching cases in the medical teaching case database; searching the medical teaching case database based on the search criteria for identifying relevant medical teaching cases; and displaying at least a portion of the text or image information of at least one of the relevant medical teaching cases.

According to a second embodiment of the present invention, a system for displaying a plurality of relevant medical teaching cases from a search of a medical teaching case database is provided. The system can include a memory having a medical teaching case database comprising medical teaching cases including medical case text and image information. The system can also include an input operable to enter search criteria for relevant medical teaching cases in the medical teaching case database. Additionally, the system can also include a search engine operable to search the medical teaching case database based on the search criteria for identifying the relevant medical teaching cases. The system can further include a display operable to display at least a portion of the text or image information of at least one of the relevant medical teaching cases.

According to a third embodiment of the present invention, a computer-readable medium having stored thereon instructions for displaying relevant medical teaching cases in a medical teaching case database is provided. The instructions of the computer-readable medium can include a step for providing a medical teaching case database comprising medical teaching cases including medical case text and image information. The instructions can also include one or more of the following steps: entering search criteria for relevant medical teaching cases in the medical teaching case database; searching the medical teaching case database based on the search criteria for identifying the relevant medical teaching cases; and displaying at least a portion of the text or image information at least one of the relevant medical teaching cases.

According to a fourth embodiment of the present invention, a method for adding a medical teaching case to a medical teaching case database is provided. The method can include a step for providing medical teaching case database comprising medical teaching cases including medical case text and image information. The method can also include a step for entering medical case image and text information into a new medical teaching case. Further, the method can include a step for adding the new medical teaching case to the medical teaching case database.

According to a fifth embodiment of the present invention, a system for adding a medical teaching case to a medical teaching case database is provided. The system can include a memory having a medical teaching case database comprising medical teaching cases including medical case text and image information. The system can also include an input operable to enter medical case image and text information into a new medical teaching case. Further, the system can include a database manager operable to add the new medical teaching case into the medical teaching case database.

According to a sixth embodiment of the present invention, a computer-readable medium having stored thereon instructions for adding a medical teaching case to a medical teaching case database is provided. The instructions of the computer-readable medium can include a step for providing a medical teaching case database comprising medical teaching cases including medical case text and image information. The instructions can also include a step for entering medical case image and text information of a medical case into a new medical teaching case. Further, the instructions can include adding the new medical teaching case into the medical teaching case database.

According to a seventh embodiment of the present invention, a computer-readable medium having stored thereon a data structure is provided. The data structure can include a first data field containing data representing image information. The data structure can also include a second data field containing data representing text information.

Accordingly, it is an object of the present invention to provide a medical teaching case database.

It is another object of the present invention to provide for searching, displaying, and managing medical teaching cases in a medical teaching case database.

Some of the objects of the invention having been stated hereinabove, other objects will become evident as the description proceeds when taken in connection with the accompanying drawings as best described hereinbelow.

### BRIEF DESCRIPTION OF THE DRAWINGS

Exemplary embodiments of the invention will now be explained with reference to the accompanying drawings, of which:

FIG. 1 is a schematic view of an exemplary medical teaching case system including a server computer having a medical teaching case database and operably connected to local client computers and remote client computers;

FIG. 2 is a schematic view of the server computer shown in FIG. 1 according to an embodiment of the present invention;

FIG. 3 is a flow chart illustration of a process for displaying relevant medical teaching cases according to an embodiment of the present invention;

FIG. 4A is a schematic view of a screen display of a search menu according to an embodiment of the present invention;

FIG. 4B is a schematic view of a screen display of another menu that corresponds with and can be displayed simultaneous with the search menu shown in FIG. 4A;

FIG. 5A is a schematic view of a screen display of an exemplary search results screen for displaying a portion of the medical case text and images of relevant medical teaching cases;

FIG. 5B is a schematic view of a screen display of a menu that corresponds with and can be displayed simultaneous with the search menu shown in FIG. 5A;

FIG. 6A is a schematic view of an exemplary screen display of a selected medical teaching case according to an embodiment of the present invention;

FIG. 6B is a schematic view of a screen display of a menu that corresponds with and can be displayed simultaneous with the search menu shown in FIG. 6A;

FIG. 7 is a schematic view of a screen display of images of additional radiology scans and photographs according to an embodiment of the present invention;

FIG. 8 is a schematic view of a screen display for displaying images of additional pathology slides, operative photographs, gross specimens according to an embodiment of the present invention;

FIG. 9 is a schematic view of an exemplary screen display of a medical teaching case for testing according to an embodiment of the present invention;

FIG. 10 is a schematic view of an answer screen display for the medical teaching case shown in FIG. 9 according to an embodiment of the present invention; and

FIG. 11 is a flow chart illustration of a process for adding a new medical teaching case to a medical teaching case database according to an embodiment of the present invention.

### DETAILED DESCRIPTION OF THE INVENTION

In accordance with the present invention, systems and methods for searching, displaying and managing medical teaching cases in a medical teaching case database are provided. The systems and methods according to the present invention will be explained in the context of flow charts, diagrams, and screen displays. It is understood according to this invention that the flow charts, diagrams, and screen displays can be implemented in hardware, software, or a combination of hardware and software. Thus, the present invention can include computer program products comprising computer-executable instructions embodied in computer-readable media for performing the steps illustrated in each of the flow charts, implementing the machines illustrated in each of the diagrams, or generating screen displays. In one embodiment, the hardware and software for searching, displaying, and managing medical teaching cases in a medical teaching case database are located in client and server computers having communication via a network such as the Internet. Alternatively, the hardware and software for searching, displaying, and managing medical teaching cases in a medical teaching case database can be located in a single stand-alone or general purpose computer.

Although the present invention is described herein below with respect to medical teaching cases, it is anticipated that the systems and methods can be utilized for storing and managing medical data of patients. Specifically, for example, the medical teaching case systems and methods can be applied to the medical record keeping of any type of audio/visual and/or visual information related to the diagnosis, management, and treatment of a patient.

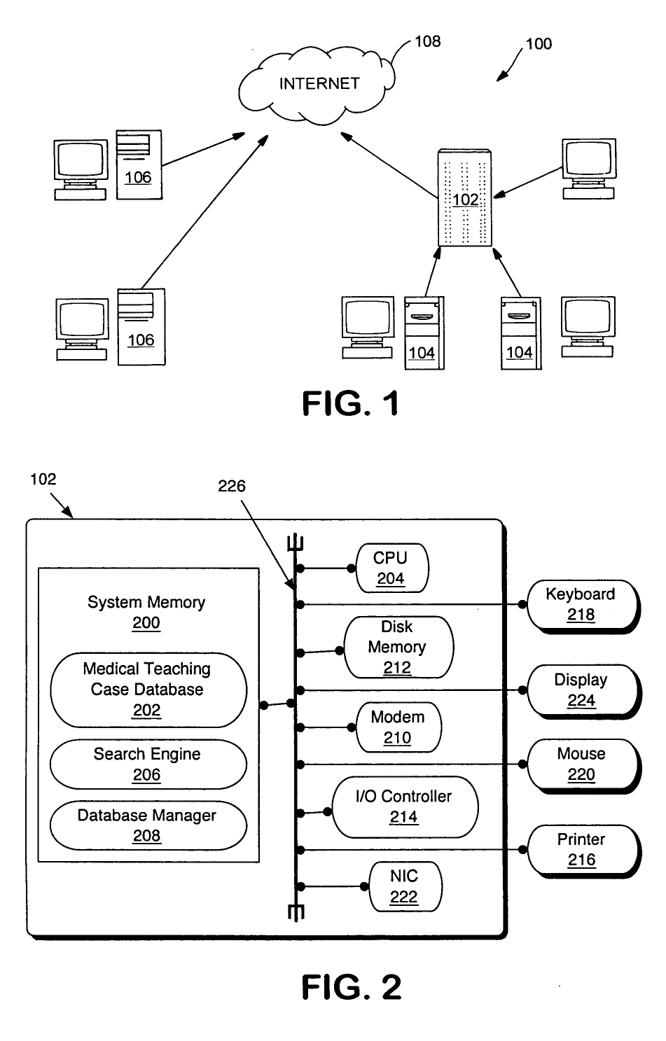

Referring to FIG. 1, an exemplary medical teaching case system, generally designated 100, is illustrated including a server computer 102 having a medical teaching case database and operably connected to local client computers 104 and remote client computers 106. Local and remote client computers 104 and 106 can be general purpose computers such as a personal computer (PC) or workstation, but can also include specialized computers for various applications as well, such as printers, palmtop computers, or scanners. Server computer 102 and local client computers 104 can include network interface cards (NICs), which allows them to communicate with each other via a network connection such as ethernet token ring, or any other suitable topology or mechanism known to those of skill in the art for linking computers in a local area network (LAN). Server computer 102 and remote computers 106 can include modems, which allows them to communicate with each other via the Internet 108. Alternatively, computers 102,104, and 106 can be connected via any other suitable communication system known to those of skill in the art such as by wireless communication. Other local or remote computers (not shown) can be connected to server computer 102 according to desired design parameters. Computers 104 and 106 are operable to access the medical teaching case database via their connection to server computer 102.

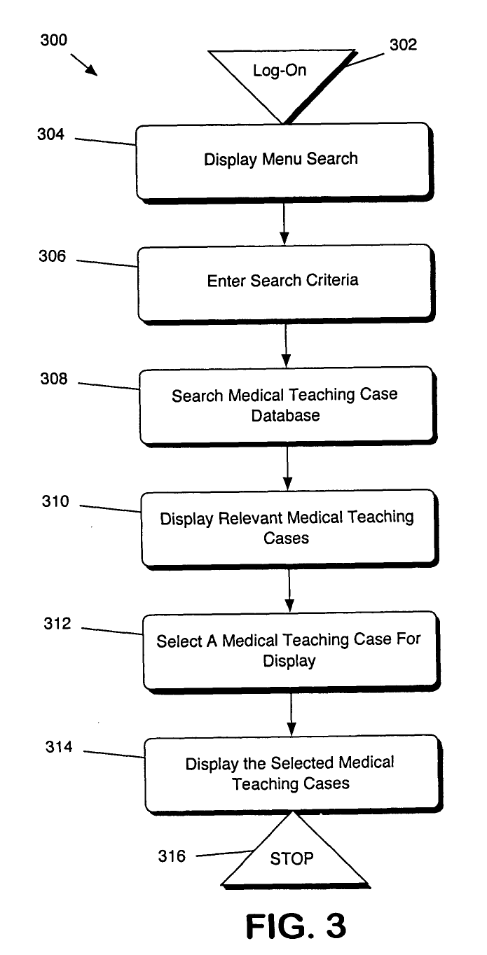

FIG. 2 illustrates a schematic diagram of server computer 102 according to an embodiment of the present invention. Computer 102 can include a system memory 200 for storing a medical teaching case database 202. Medical teaching case database 202, described in further detail below, can include medical teaching cases having medical case text and image information. Computer 102 can include hardware and/or software components for searching, displaying, and managing the medical teaching cases contained in medical teaching case database 202. As stated above, local and remote client computers 104 and 106 can access medical teaching case database 202 for remotely searching, displaying, and managing the medical teaching cases. Further, computer 102 can exchange information related to the display of teaching cases and management of medical teaching case database 202 with local and remote client computers 104 and 106. Alternatively, computer 102 can be a stand-alone or general purpose computer such as a PC-compatible computer for searching, displaying, and managing medical teaching cases in medical teaching case database 202 according to the present invention.

Computer 102 can include a central processing unit (CPU) 204 operable to execute instructions loaded from system memory 200 to implement searching, displaying, and managing of the medical teaching cases of medical teaching case database 202. CPU 204 can comprise a single microprocessor, or can contain a plurality of microprocessors for configuring computer 102 as a multi-processor computer. System memory 200 can also include a search engine 206 and a database manager 208 having instructions for implementing the search, management and display of the medical teaching cases. In one embodiment, search engine 206 and database manager 208 can include structured query language (SQL), a standardized query language. Alternatively, search engine 206 and database manager 208 can include a software database application such as FILEMAKER 5.5v2 UNLIMITED produced by FileMaker, Inc. of Santa Clara, Calif. The instructions of system memory 200 can be stored on banks of dynamic random access memory (DRAM) as well as high-speed cache memory. Search engine 206 can include instructions for searching medical teaching case database 202 based on search criteria entered by an operator of server computer 102, local client computer 104, or remote client computer 106. Alternatively, search engine 206 can reside on local client computer 104 or remote client computer 106 for remotely accessing and searching medical teaching case database 202. Database manager 208 can include instructions for managing medical teaching cases of medical teaching case database 202 such as adding new medical teaching cases and searching medical teaching case database 202. Alternatively, database manager 208 can reside on local client computer 104 or remote client computer 106 for remotely accessing and searching medical teaching case database 202. In alternate embodiments, search engine 206, database manager 208, medical teaching case database 202, and instructions and methods according to the present invention can be stored, wholly or partially, in CPU 204, disk memory 212 or other components of computer 102. Alternatively, search engine 206, database manager 208, medical teaching case database 202, and instructions and methods according to the present invention can be stored in local or remote computers 104 and 106 (shown in FIG. 1).

Computer 102 can include the following additional components: a modem 210, a disk memory 212, an input/output (I/O) controller 214, a printer 216, a keyboard 218, a mouse 220, a network interface card (NIC) 222, and a display 224. For simplicity, the components of computer 102 shown in FIG. 2 are depicted as being connected via a single bus 226. Alternatively, the components can be connected through one or more data transport means. For example, CPU 204 and system memory 200 can be connected via a local microprocessor bus. Additionally, for example, printer 216, keyboard 218, mouse 220, NIC 222, and display 224 can be connected via one or more input/output buses. An operator can input alpha-numeric and other information into computer 102 via inputs such as keyboard 218 and mouse 220. Alternatively, computer 102 can include other inputs such as a trackball, stylus or touchscreen display for inputting information. Printer 216 and display 224 can display text and image information of the medical teaching cases in medical teaching case database 202. Disk memory 212 can operate with a portable computer-readable medium, such as a floppy disk, or other computer-readable medium, to input and output data and code to and from server computer 102. CPU 204 and I/O controller 214 can manage the operation of modem 210.

### Medical Teaching Case Database

As stated above, medical teaching case database 202 can include medical teaching cases having medical case text and image information. As stated above, medical teaching case database 202 can be stored, wholly or partially, in the memory or CPU of a computer or any other suitable computer-readable medium known to those of skill in the art such as a floppy disk, zip disc, hard disk, or any type of optically-read medium, such as a compact disc. The medical teaching cases of medical teaching case database 202 can be searched for display to an operator. Additionally, medical teaching case database 202 can be managed by an operator via search engine 206 and database manager 208. Management of medical teaching case database 202 can include adding new medical teaching cases and editing existing medical teaching cases.

In one embodiment, medical teaching case database 202 contains medical teaching cases of radiological medical cases of the head and neck. Alternatively, a medical teaching case database according to the present invention can contain medical teaching cases including, but not limited to, pathology, dermatology, ophthalmology or medical teaching cases related to any other suitable medical field known to those of skill in the art. Medical teaching case database 202 can comprise a data structure for representing a medical case. The data structure can include data fields having data representing different categories of medical case image and text information. Additionally, the data fields can provide a link to data containing further related medical image and/or text information. The following table lists the data fields of medical case text information of a medical teaching case according to an embodiment of the present invention and a description of the content of the associated data field:

| DATA FIELD | CONTENT DESCRIPTION |
|---|---|
| Classification | Text representing the classification of |
| | the medical case of a patient according |
| | to a general diagnosis category. |
| Diagnosis | Text representing the diagnosis of the |
| | patient. |
| Age | Text representing patient age. |
| Gender | Text representing patient gender. |
| Teaching Case | Data indicating whether the medical |
| | case is a standout case for teaching |
| | purposes. |
| History | Text representing a description of the |
| | pertinent historical and physical |
| | examination of the medical case. |
| Film Box | Data indicating an image that most |
| | illustrates the diagnosis. |
| Educational Points | Text representing a description of |
| | pertinent educational points. |
| Clinical Keywords | Text representing keywords of the |
| | classic clinical keywords data field. |
| Radiologic | Text representing keywords of the |
| Keywords | classic radiologic keywords data field. |
| Image Check | Data indicating whether the medical |
| | teaching case has been independently |
| | verified by a radiologist. |
| Clinical Check | Data indicating whether the medical |
| | teaching case has been independently |
| | verified by a clinician of the appropriate |
| | specialty. |
| Case Number | Text representing a case reference |
| | number. |
| Film Year | Text representing a number for the year |
| | the images were obtained. |
| Location | Text representing the location of the |
| | pathology, for example, temporal bone, |
| | nose/sinus, neck, oropharynx, |
| | superficial, joint, abdomen, brain, and |
| | breast. |
| Date Modified | Text representing the date of the last |
| | modification to the record. |
| Date Created | Data representing the date the record |
| | was created. |
| Weird Factor | Text representing a ranking (1-5) of the |
| | medical case ranging from most classic |
| | (1) to most unusual (5). |
| Complete | Data indicating whether all elements of |
| | the medical teaching case are complete. |
| Submitter | Data identifying the person submitting |
| | the medical case. |
| E-mail | Data representing the E-mail address of |
| | the person submitting the medical case. |
| Specialization | Data representing the specialty of the |
| | submitting person, if a physician. |
| Private Practice | Data indicating whether the submitting |
| | person is in private practice. |
| Affiliated Institution | Data representing the institution of |
| | association of the submitting person, if |
| | the submitting person is not in private |
| | practice. |

The data structure of the medical teaching case database can also include data fields representing image information. Case images can be converted and stored into a computer-readable medium from pathology slides, photographs of gross specimens, photographs of lesions, radiology films or any other known medical imaging medium. Case images can be stored as a computer-readable medium in any suitable format known to those of skill in the art such as DICOM (Digital Imaging and Communications in Medicine) format, tagged image file format (TIFF), joint photographic experts group (JPEG) format, graphics interchange format (GIF), or QuickTime ™format produced by Apple Computer, Inc.

### Display of Relevant Medical Teaching Cases

A method for displaying relevant medical teaching cases according to the present invention includes searching medical teaching case database 202 based on search criteria entered by an operator. Search engine 206 can perform a search of medical teaching case database 202 based on the entered search criteria. The purpose of searching medical teaching case database 202 is to identify relevant medical teaching cases for display to the operator. Relevant medical teaching cases are the medical teaching cases of medical teaching case database 202 that include data matching at least some of the entered search criteria.

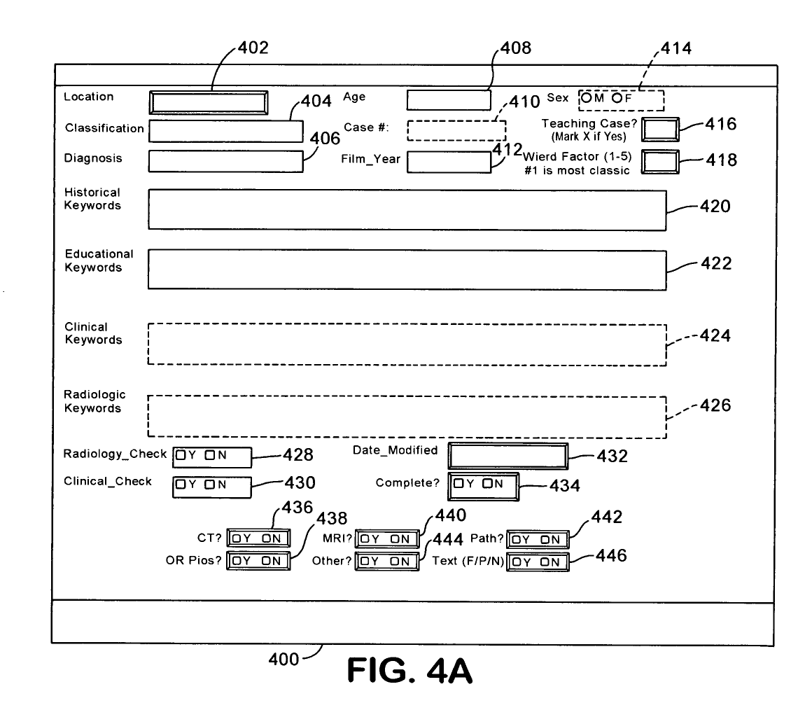

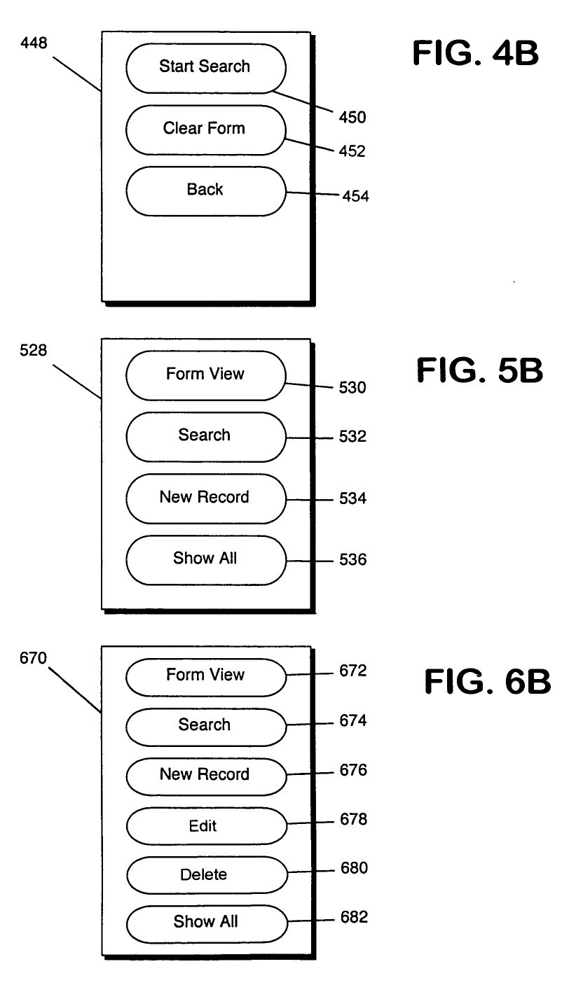

Referring to FIG. 3, a flow chart, generally designated 300, is provided which illustrates a process for displaying relevant medical teaching cases according to an embodiment of the present invention. FIG. 3 is discussed below in connection with FIGS. 4-8 which correspond to screen displays generated by display 224. As stated above, the display of relevant medical teaching cases includes searching medical teaching case database 202 based on entered search criteria. Search engine 206 is operable to perform the search of medical teaching case database 202. The process begins at the step indicated by reference numeral 302, wherein an operator can log on to computer 102. Display 224 can generate a log on display screen including one or more display fields, wherein an operator can enter security information, such as a user name and password, e-mail address, and place of work, for accessing medical teaching case database 202. For remote access of medical teaching case database 202, an operator can transmit security information from a local or remote client computer. Computer 102 checks the entered security information and permits access to operators entering valid security information.

On the entry of valid security information, display 224 generates a search menu display having optional display fields (step 304) for prompting the operator to enter various search criteria to perform a search of medical teaching case database 202. Referring to FIG. 4A, a schematic view of a screen display 400 of a search menu according to an embodiment of the present invention is illustrated. In this embodiment, screen display 400 includes the following display fields: location 402, classification 404, diagnosis 406, age 408, case number 410, film year 412, sex 414, teaching case 416, weird factor 418, historical keywords 420, educational keywords 422, clinical keywords 424, radiologic keywords 426, radiology check 428, clinical check 430, date modified 432, complete 434, computed tomography (CT) image 436, Interoperative (OR) photographs 438, magnetic resonance imaging (MRI) 440, pathology 442, other 444, and text (full/partial/no text) 446.

The operator can enter search criteria into one or more display fields for searching the data fields of medical teaching case database 202 for relevant teaching cases. Relevant medical teaching cases are those medical teaching cases identified by search engine 206 that match at least a portion of the entered search criteria. In this embodiment, each display field corresponds to one of the data fields of a medical teaching case. Search engine 206 searches the data fields of medical teaching case database 202 based on the search criteria entered into corresponding display fields. In this embodiment, all of the entered search criteria entered into display fields must match corresponding data fields for the record to be identified as relevant. In an alternative embodiment, screen display 400 can include an AND field and an OR field for selecting either the AND Boolean operator or OR operator, respectively, for searching data fields according to Boolean operations. For example, when the AND field is selected, relevant medical teaching cases are the medical teaching cases having data fields that match all of the search criteria entered into corresponding display fields. When the OR field is selected, relevant medical teaching cases are the medical teaching cases having data fields that match at least one of the search criteria entered into a corresponding display field.

One or more search keywords can be entered in location field 402, classification field 404, and/or diagnosis field 406 for searching the diagnosis data fields of medical teaching case database 202. In an alternative embodiment, search criteria can be entered into the display fields by selection of one or more search criteria selected from the display field, such as a display field having a pull-down menu or a display field having two or more selectable icons. Additionally, in an alternative embodiment, for example, location field 402 and classification field 404 can comprise a pull-down menu for selecting from a list of a pathology location and/or classification search criteria, respectively.

A single search numeral or range of search numerals can be entered in age field 408, case number field 410, and/or film year field 412 for searching the age data fields, the case number data fields, and/or the film year data fields, respectively. The male (M) or female (F) icon in sex field 414 can be selected for searching the gender data fields. The alphanumeric character “X” can be entered in teaching case field 416 for searching the teaching case data fields. One or more alphanumeric characters among numbers 1-5 can be entered in weird factor field 418 for searching the weird factor data fields. One or more search keywords can be entered in historical keywords field 420, educational keywords field 422, clinical keywords field 424, and/or radiologic keywords field 426 in accordance with Boolean search operations for searching the historical data fields, educational data fields, the clinical data fields and/or the radiologic data fields, respectively.

Radiology check 428 can be selected for searching the teaching cases cleared by a radiology specialist. Clinical check 430 can be selected for searching the teaching cases cleared by a clinical specialist. A date or range of dates can be entered into date modified 432 for searching for the dates that a teaching case was last modified. Complete 434 can be selected for searching the teaching cases that have been completed. CT image 436 can be selected for searching the teaching cases having CT images. Interoperative photographs (OR) 438 can be selected for searching the teaching cases having intra-op photographs of gross pathology. MRI 440 can be selected for searching the teaching cases having images of type MRI. Pathology 442 can be selected for searching the teaching cases having pathology slide images. Other 444 can be selected for searching the teaching cases having images that do not correspond to a search of cases corresponding to CT images, intra-op photographs, MRI images, or pathology slide images. Other 444 can include any type of radiographic images other than CT images, such as angiographic, myelographic, ultrasound, PET, nuclear medicine, and plain films. In this exemplary embodiment, a Y or N box can be entered into fields 428, 430, 432, 434, 436, 438, 440, 442, and 444 to specify whether the respective fields are used in the search. An F, P, or N can be entered into text 446 for searching the teaching cases having full, partial, or no text, respectively, within the historical or educational text fields.

At step 306, the operator can enter search criteria into one or more display fields of screen display 400 for searching the corresponding data fields of medical teaching case database 202. In this embodiment, keyboard 218 and mouse 220 can be used for entering search criteria into the display fields of screen display 400. Referring to FIG. 4B, a schematic view of a screen display 448 that can be displayed simultaneous with the search menu of FIG. 4A is illustrated. Screen display 448 can overlay the search menu for view by the operator and include selectable icons for implementing search related functions. Screen display 448 can include a start search icon 450 for selection by the operator to initiate a search based on the entered search criteria. Additionally, screen display 448 can include a clear form icon 452 for clearing the entered search criteria from the search menu and a back icon 454 for returning to a search menu having previously entered search criteria.

After the operator selects start search icon 450 for initiating a search, search engine 206 searches the data fields of the medical teaching case database 202 based on the search criteria entered in the corresponding fields of screen display 400 (step 308). Search engine 206 can identify relevant medical teaching cases by matching search criteria to the contents of the data fields of medical teaching case database 202 in accordance with standard Boolean search operations.

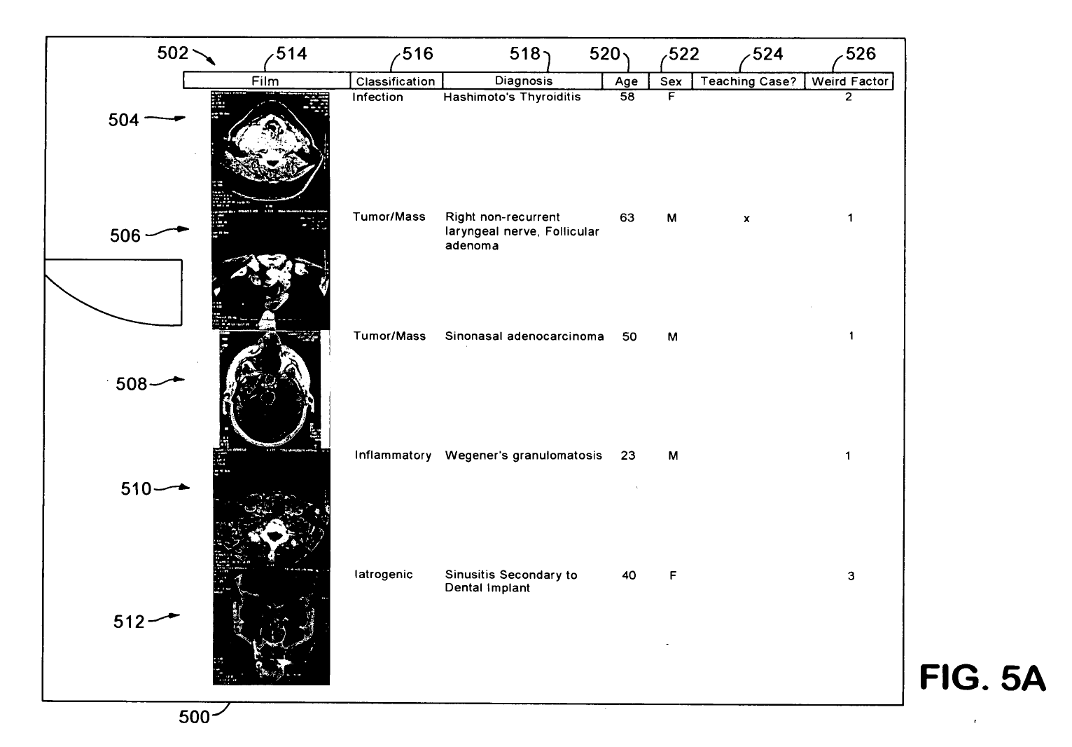

Next, display 224 can display the relevant medical teaching cases on a search results screen (step 310). Referring to FIG. 5A, a schematic view of a screen display 500 of an exemplary search results screen for displaying a portion of the medical case text and images of relevant medical teaching cases according to an embodiment of the present invention is illustrated. Screen display 500 displays a table, generally designated 502, including a portion of the medical case text and images of one or more relevant medical teaching cases identified in a search. In this search results example, search engine 206 identified five relevant medical teaching cases, generally designated 504, 506, 508, 510, and 512. In this embodiment, table 502 includes data columns corresponding to some of the data fields of a medical teaching case. Table 502 can include the following data columns: a film column 514 for displaying the medical image of the medical teaching case that most illustrates the diagnosis; a classification column 516 for displaying the text of the classification data field; a diagnosis column 518 for displaying the text of the diagnosis data field; an age column 520 for displaying the text of the age data field; a patient sex column 522 for displaying the text of the gender data field; a teaching case column 524 for displaying an alphanumeric character “X” if the medical teaching case is indicated as a teaching case; and a weird factor data column 526 for displaying the text of the weird factor data field. The information displayed in columns 514, 516, 518, 520, 522, 524, and 526 represent a portion of the information contained in the data fields of the medical teaching cases. Alternatively, all the data fields of the relevant medical teaching cases can be displayed on display screen 500.

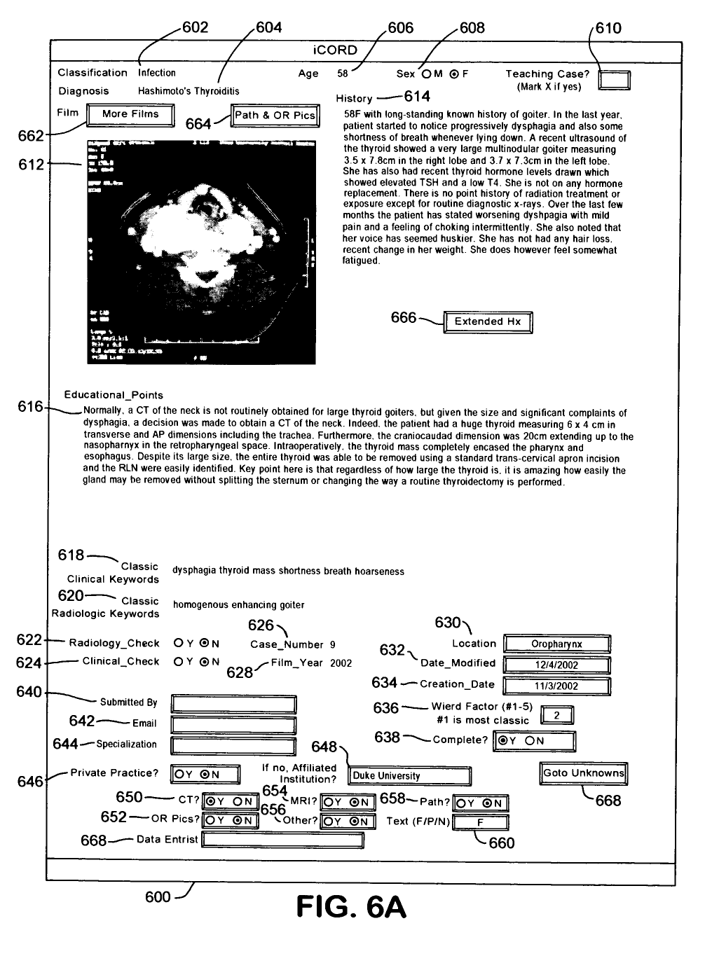

Referring to FIG. 5B, a schematic view of a screen display 528 that can be simultaneous displayed with the search menu of FIG. 5B is illustrated. Screen display 528 can overlay the search menu for view by the operator. Screen display 528 can include a form view icon 530 for displaying the screen shown FIG. 6A and described in detail below; a search icon 532 for returning to the search menu to begin a new search; a new record icon 534 to provide a new record menu for entering a new record into database 202; and a show all icon for displaying all of the records contained in database 202.

At step 312, the operator can select one of the relevant medical teaching cases for displaying only the image and text information in the selected medical teaching case. Next, a selected medical teaching case can be displayed (step 314) and the searching process then stops (step 316). Referring to FIG. 6A, a schematic view of an exemplary screen display 600 of a selected medical teaching case according to an embodiment of the present invention is illustrated. Medical teaching case 504 shown in FIG. 5A is illustrated in this example. The following table lists a description of the text and image information displayed by screen display 600:

| DISPLAY FIELD | CONTENT DESCRIPTION |
|---|---|
| Classification 602 | Text of the classification data field. |
| Diagnosis 604 | Text of the diagnosis data field. |
| Age 606 | Text of the age data field. |
| Sex 608 | Text of the gender data field. |
| Teaching Case 610 | Data for displaying an alphanumeric |
| | character “X” if the medical teaching |
| | case is indicated as a teaching case. |
| Film Box 612 | Data for displaying the image indicated |
| | in the film box data field. |
| History 614 | Text of the history data field. |
| Educational Points | Text of the education points data field. |
| 616 | |
| Clinical Keywords | Keywords of the classic clinical |
| 618 | keywords data field. |
| Radiologic | Keywords of the classic radiologic |
| Keywords 620 | keywords data field. |
| Image Check 622 | Indication whether the teaching case |
| | has been cleared by a radiology |
| | specialist. |
| Clinical Check 624 | Indication whether the teaching case |
| | has been cleared by a clinical specialist |
| Case Number 626 | Text of the case number data field. |
| Film Year 628 | Text of the film year data field. |
| Location 630 | Text of the location data field. |
| Date Modified 632 | Text of the date modified data field. |
| Date Created 634 | Data of the date created data field. |
| Weird Factor 636 | Text of the weird factor data field. |
| Complete 638 | Indication of whether the medical |
| | teaching case is complete according to |
| | the complete data field. |
| Submitter 640 | Text of the specialization data field. |
| E-mail 642 | Text of the E-mail data field. |
| Specialization 644 | Data representing the specialty of the |
| | submitting person, if a physician. |
| Private Practice | Indication of whether the submitting |
| 646 | person is in private practice according to |
| | the private practice data field. |
| Affiliated Institution | Data representing the institution of |
| 648 | association of the submitting person, if |
| | the submitting person is not in private |
| | practice. |
| CT display field | Specifies whether CT images are |
| 650 | included in the record |
| OR Display Field | Specifies whether intra-operative |
| 652 | surgical field images are included in the |
| | record. |
| MRI Display Field | Specifies whether MRI images are |
| 654 | included in the record. |
| Other Display Field | Specifies whether images that are not of |
| 656 | CT, MRI, OR, or pathology type images |
| | are included in the record. |
| Path Display Field | Specifies whether pathology slide |
| 658 | images are included in the record. |
| Text Display Field | Specifies teaching cases having full, |
| 660 | partial, or no text (F, P, or N, |
| | respectively) within the historical or |
| | educational text fields. |

Screen display 600 can include a more films icon 662 and a path & OR (operating room) pics icon 664 for displaying additional medical case images. Display 226 can display additional images of radiology scans and photographs when the operator selects more films icon 662.

Referring to FIG. 6B, a schematic view of a screen display 670 that can be displayed simultaneous with the search menu of FIG. 6A is illustrated. Screen display 670 can overlay the search menu for view by the operator. Screen display 670 can include a table view icon 670 for displaying the screen shown in FIG. 5A; a search icon 672 for initiating a search, search engine 206 searches the data fields of the medical teaching case database 202 based on the search criteria entered in the corresponding fields of screen display 400; a new record icon 676 to provide a new record menu for entering a new record into database 202; an edit record icon 678 for allowing operators with administrative privileges to edit the currently displayed case, such as modifying the entries in classification field 602; a delete record icon 680 for allowing operators with administrative privileges to delete the currently displayed case; and a show all icon 682 for displaying all of the records contained in database 202.

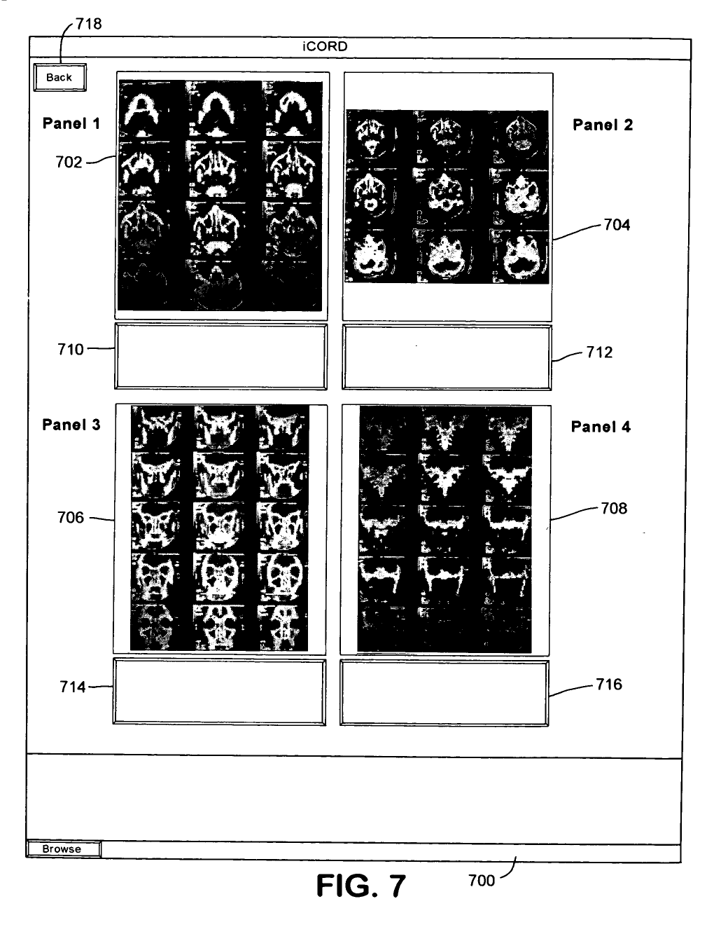

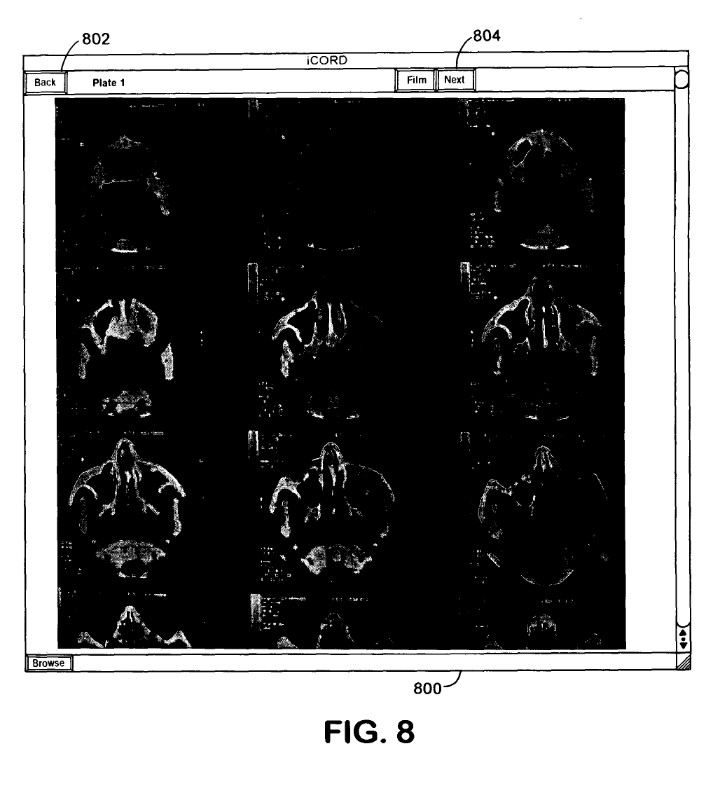

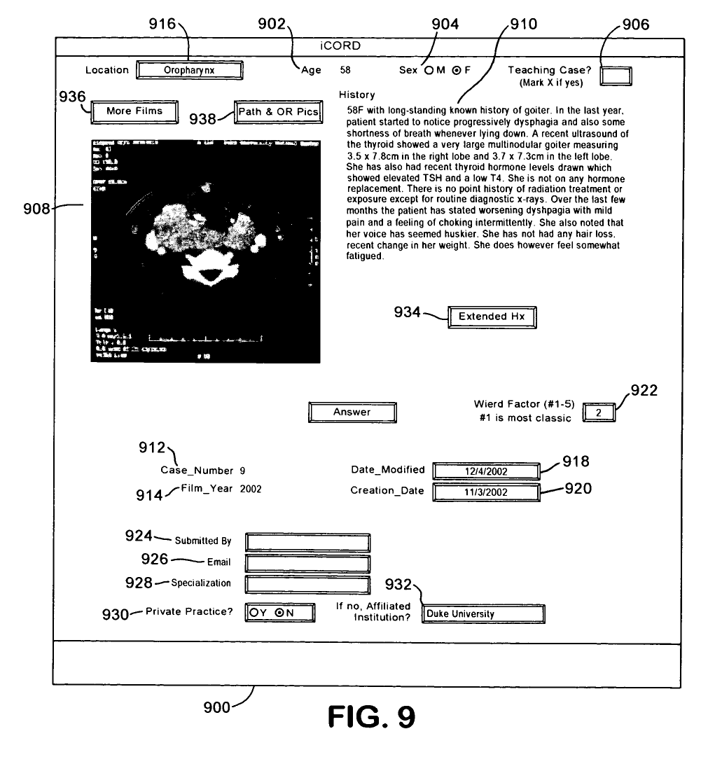

Referring to FIG. 7, a schematic view of a screen display 700 of images of additional radiology scans and photographs according to an embodiment of the present invention is illustrated. Screen display 700 can include panels 702, 704, 706, and 708 for displaying additional radiology scans and photographs. Panels 702, 704, 706, and 708 can include display fields 710, 712, 714, and 716, respectively, for the display of text describing the associated panel. Screen display 700 can also include a back icon 718 for returning to screen display 600 (shown in FIG.6) for the medical teaching case. Referring again to FIG. 6, display 226 can display images of pathology slides, operative photographs, gross specimens when the operator selects path & OR pics icon 664. Referring to FIG. 8, a schematic view of a screen display 800 for displaying images of additional pathology slides, operative photographs, gross specimens according to an embodiment of the present invention is illustrated. Screen display 800 can include a back icon 802 for returning to screen display 600 (shown in FIG. 6) for the medical teaching case. Screen display 800 can also include a next icon 804 for displaying any additional pathology slides, operative photographs, and gross specimens. Referring again to FIG. 6, screen display 600 can include an extended history icon 666 for displaying a screen display having additional history information. Screen display 600 can also include a goto unknowns icon 668 for changing the database display that hides the diagnosis allowing individuals to test their knowledge. Goto unknowns icon 668 will shift the display to screen display 900 shown and described with respect to FIG. 9 below. Further, screen display 600 can include a data entrist icon 668 for identifying the person entering the case.

Search engine 206 can include instructions for providing additional fields on display 224 for accessing medical teaching case database 202. These additional fields include fields for selecting the first or last record of medical teaching case database 202 for display. A zoom in and zoom out field can be displayed for “magnifying” or “demagnifying” the currently displayed image. A normal zoom field can be displayed for allowing the displayed image to return from a “magnified” or “demagnified” view. A sort field can be displayed for allowing a user to sort medical teaching case database 202 in a selected manner, such as by age and alphabetic. A show all field can be displayed for resetting the displayed records to all the records of medical teaching case database 202.

System 100 can provide a feature for testing a student, resident, physician, or other allied health professional regarding a particular diagnosis. Referring to FIG. 9, a schematic view of an exemplary screen display 900 of a medical teaching case for testing according to an embodiment of the present invention is illustrated. In this embodiment, screen display 900 displays the text and image information in the following display fields: an age display field 902 for displaying the text of the age data field; a patient sex display field 904 for displaying the text of the gender data field; a teaching case display field 906 for displaying an alphanumeric character “X” if the medical teaching case is indicated as a teaching case; a film display field 908 for displaying the image indicated in the film box data field; a history display field 910 for displaying the text of the history data field; a case number display field 912 for displaying the text of the case number data field; a film year display field 914 for displaying the text of the film year data field; a location display field 916 for displaying the text of the location data field; a date modified display field 918 for displaying the text of the date modified data field; a creation date display field 920 for displaying the text of the date create data field; a weird factor display field 922 for displaying the text of the weird factor data field; a submitted by display field 924 for displaying the text of the submitter data field; an E-mail display field 926 for displaying the text of the E-mail data field; a specialization display field 928 for displaying the text of the specialization data field; a private practice display field 930 for displaying an indication of whether the submitting person is in private practice according to the private practice data field; an affiliated institution display field 932 for displaying the text of the affiliated institution data field; and an extended history icon 934 for displaying a screen display having additional history information. Screen display 900 can also include a more films icon 936 and a path & OR (operating room) pics icon 938 for displaying additional medical case images.

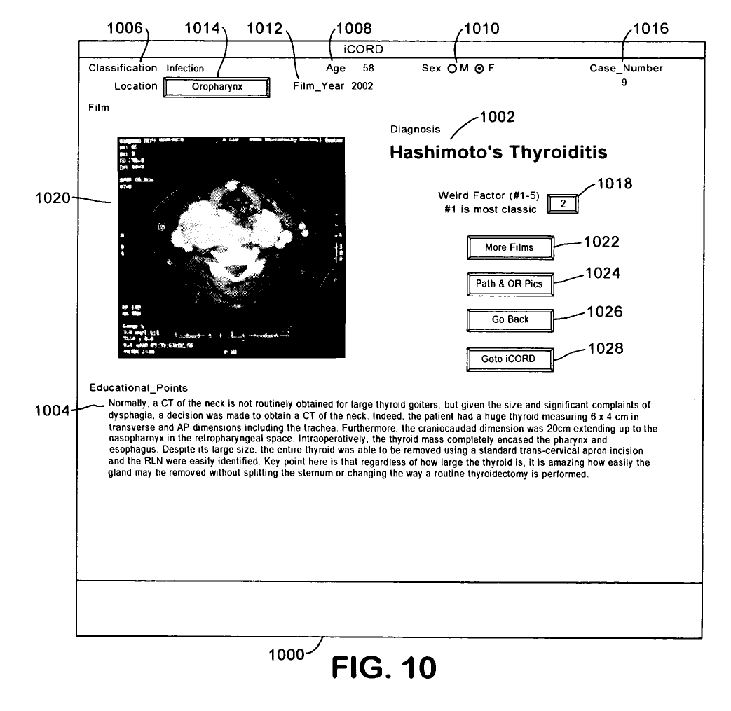

A student, resident, physician, or other health professional can evaluate the medical case presented in FIG. 9 for testing purposes. Screen display 900 includes an answer icon 940 for displaying an answer screen display. Referring to FIG. 10, a schematic view of an answer screen display 1000 for the medical teaching case shown in FIG. 9 according to an embodiment of the present invention is illustrated. Screen display 1000 can include a diagnosis display field 1002 for displaying the test of the diagnosis data field and an education points display field 1004 for displaying the text of the education points data field. The student, resident, physician, or other health professional can evaluate his or her test performance based on diagnosis display field 1002 and education points display field 1004. Screen display 1000 can also include a classification display field 1006; an age display field 1008; a patient sex display field 1010; a film year display field 1012; a location display field 1014; a case number display field 1016; a weird factor display field 1018; and a film display field 1020. Screen display 1000 can also include a more films icon 1022 and a path & OR pics icon 1024. Screen display 1000 can also include a go back icon 1026 for shifting screen display 900 to the screen display shown and described with respect to FIG. 9. Additionally, screen display 1000 can include a goto iCORD icon 1028 for returning the display to screen display 600 shown in FIG. 6.

### Management of Medical Teaching Case Database

A method for managing medical teaching case database 202 includes adding and editing medical teaching cases. Medical teaching cases can be added to medical teaching case database 202 by entering text and image information into the fields of a new medical teaching case displayed by display 224. System 100 can provide for automatic or manual image uploading by the operator. Database manager 208 is operable to add medical teaching cases to medical teaching case database 202.

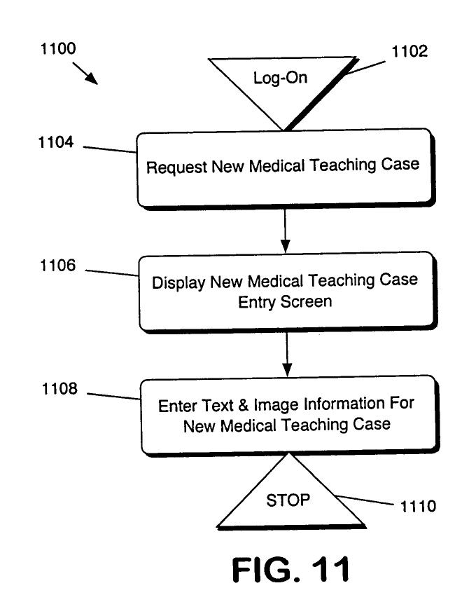

Referring to FIG. 11, a flow chart, generally designated 1100, is provided which illustrates a process for adding a medical teaching case to medical teaching case database 202 according to an embodiment of the present invention. The process begins at the step indicated by reference numeral 1102, wherein an operator can log on to computer 102. At step 1102, display 224 generates a log on display screen including one or more display fields, wherein an operator can enter security information, for accessing medical teaching case database 202 with administrative privileges. The operator must enter a user name and password valid for administrative privileges in order to access medical teaching case database 202 for the managerial purposes. Administrative privileges are denied to operators entering invalid administrative privileges information. After entering valid administrative privileges information, the operator can request input for entering the text and image information of a new medical teaching case (step 1104). In this embodiment, the request can be made by selecting an add button on a display screen. Next, display 226 generates a display screen for entering a new medical teaching case (step 1106). At step 1108, the operator enters case text and image information into the new medical teaching case. After step 1108, the process ends (step 1110).

It will be understood that various details of the invention may be changed without departing from the scope of the invention. Furthermore, the foregoing description is for the purpose of illustration only, and not for the purpose of limitation.

What is claimed is:

1. A method for displaying relevant medical teaching cases in a medical teaching case database, comprising:
(a) providing a medical teaching case database comprising medical teaching cases including medical case text and image information;
(b) entering search criteria for relevant medical teaching cases in the medical teaching case database;
(c) searching the medical teaching case database based on the search criteria for identifying relevant medical teaching cases; and
(d) displaying at least a portion of the text or image information of at least one of the relevant medical teaching cases.

2. The method according to claim 1 wherein the medical teaching case database is stored on a computer-readable medium.

3. The method according to claim 2 wherein the medical teaching case database comprises a data structure representing a medical case, the data structure comprising:
(a) a first data field containing data representing image information; and
(b) a second data field containing data representing text information.

4. The method according to claim 1 wherein entering search criteria includes displaying a search menu.

5. The method according to claim 4 wherein the search menu includes fields for entering search criteria.

6. The method according to claim 4 wherein the search menu includes a historical keyword field.

7. The method according to claim 4 wherein the search menu includes an educational keyword field.

8. The method according to claim 4 wherein the search menu includes a clinical keyword field.

9. The method according to claim 4 wherein the search menu includes a radiological keyword field.

10. The method according to claim 4 wherein the search menu includes a classification keyword field.

11. The method according to claim 10 wherein the classification keyword field comprises information related to a diagnosis category.

12. The method according to claim 4 wherein the search menu includes a diagnosis keyword field.

13. The method according to claim 4 wherein the search menu comprises fields selected from the keyword field group consisting of age, location, gender, teaching, history, image year, date modified, date created, weird factor, complete, or physician and combinations thereof.

14. The method according to claim 1 wherein entering search criteria includes providing an input operable to receive search criteria from an operator.

15. The method according to claim 1 wherein entering search criteria includes entering text information.

16. The method according to claim 1 wherein entering search criteria includes entering Boolean operators.

17. The method according to claim 1 wherein entering search criteria includes entering keywords into keyword fields displayed on a search menu.

18. The method according to claim 17 wherein entering search criteria includes entering a historical keyword into a historical keyword field displayed on a search menu on a display.

19. The method according to claim 17 wherein entering search criteria includes entering an educational keyword into an educational keyword field displayed on a search menu on a display.

20. The method according to claim 17 wherein entering search criteria includes entering a clinical keyword into a clinical keyword field displayed on a search menu on a display.

21. The method according to claim 17 wherein entering search criteria includes entering a radiological keyword into a radiological keyword field displayed on a search menu on a display.

22. The method according to claim 17 wherein entering search criteria includes entering a classification keyword into a classification keyword field displayed on a search menu on a display.

23. The method according to claim 17 wherein entering search criteria includes entering an age keyword into an age keyword field displayed on a search menu on a display.

24. The method according to claim 17 wherein entering search criteria includes entering a diagnosis keyword into a diagnosis keyword field displayed on a search menu on a display.

25. The method according to claim 1 wherein step (c) further includes searching the text of the medical teaching case database based on Boolean operators.

26. The method according to claim 1 wherein step (d) includes accessing a digital imaging application for displaying image information.

27. The method according to claim 1 further including selecting one of the relevant medical teaching cases.

28. The method according to claim 27 further including displaying at least a portion of the text and image information of the selected one of the relevant medical teaching cases.

29. The method according to claim 1 further including accessing the medical teaching case database via the Internet.

30. The method according to claim 1 further including providing security information for accessing the medical teaching case database.

31. A system for displaying a plurality of relevant medical teaching cases from a search of a medical teaching case database, comprising:
(a) a memory including a medical teaching case database comprising medical teaching cases including medical case text and image information;
(b) an input operable to enter search criteria for relevant medical teaching cases in the medical teaching case database;
(c) a search engine operable to search the medical teaching case database based on the search criteria for identifying the relevant medical teaching cases; and
(d) a display operable to display at least a portion of the text or image information of at least one of the relevant medical teaching cases.

32. The system according to claim 31 wherein the medical teaching case database comprises a data structure representing a medical case, the data structure comprising:
(a) a first data field containing data representing the image information; and
(b) a second data field containing data representing the text information.

33. The system according to claim 31 wherein the display is operable to display a search menu for entering search criteria.

34. The system according to claim 33 wherein the search menu includes fields for entering text information for search.

35. The system according to claim 33 wherein the search menu includes a historical keyword field.

36. The system according to claim 33 wherein the search menu includes an educational keyword field.

37. The system according to claim 33 wherein the search menu includes a clinical keyword field.

38. The system according to claim 33 wherein the search menu includes a radiological keyword field.

39. The system according to claim 33 wherein the search menu includes a classification keyword field.

40. The system according to claim 39 wherein the classification keyword field comprises information related to a diagnosis category.

41. The system according to claim 31 wherein the search menu comprises fields selected from the keyword field group consisting of an age, location, gender, teaching, history, image year, date modified, date created, weird factor, complete, or physician and combinations thereof.

42. The system according to claim 31 wherein the search criteria includes text information.

43. The system according to claim 31 wherein the search criteria includes Boolean operators.

44. The system according to claim 31 wherein the input is further operable to enter keywords into keyword fields displayed on a search menu displayed on the display.

45. The system according to claim 43 wherein the keywords include a historical keyword for entry into a historical keyword field displayed on the search menu.

46. The system according to claim 43 wherein the keywords include an educational keyword for entry into an educational keyword field displayed on the search menu.

47. The system according to claim 43 wherein the keywords include a clinical keyword for entry into a clinical keyword field displayed on the search menu.

48. The system according to claim 43 wherein the keywords include a radiological keyword for into a radiological keyword field displayed on the search menu.

49. The system according to claim 43 wherein the keywords include a classification keyword for entry into a classification keyword field displayed on the search menu.

50. The system according to claim 43 wherein the keywords include an age keyword for entry into an age keyword field displayed on the search menu.

51. The system according to claim 43 wherein the keywords include a diagnosis keyword for entry into a diagnosis keyword field displayed on the search menu.

52. The system according to claim 31 wherein the search engine is further operable to search the text of the medical teaching case database based on Boolean operators.

53. The system according to claim 31 wherein the input is operable to select one of the relevant medical teaching cases.

54. The system according to claim 56 wherein the display is further operable to display the text and image information of the selected one of the relevant medical teaching cases.

55. The system according to claim 31 wherein the medical teaching case database is operable for access via the Internet.

56. A computer-readable medium having stored thereon instructions for displaying relevant medical teaching cases in a medical teaching case database, comprising:
(a) providing a medical teaching case database comprising medical teaching cases including medical case text and image information;
(b) entering search criteria for relevant medical teaching cases in the medical teaching case database;
(c) searching the medical teaching case database based on the search criteria for identifying the relevant medical teaching cases; and
(d) displaying at least a portion of the text or image information at least one of the relevant medical teaching cases.

57. The computer-readable medium according to claim 56 wherein the medical teaching case database comprises a data structure representing a medical case, the data structure comprising:
(a) a first data field containing data representing image information; and
(b) a second data field containing data representing text information.

58. The computer-readable medium according to claim 56 wherein entering search criteria includes displaying a search menu.

59. The computer-readable medium according to claim 56 wherein the search menu includes fields for entering search criteria.

60. The computer-readable medium according to claim 56 wherein the search menu includes a historical keyword field.

61. The computer-readable medium according to claim 56 wherein the search menu includes a clinical keyword field.

62. The computer-readable medium according to claim 56 wherein the search menu includes a radiological keyword field.

63. The computer-readable medium according to claim 56 wherein the search menu includes a classification keyword field.

64. The computer-readable medium according to claim 56 wherein the classification keyword field comprises information related to a diagnosis category.

65. A method for adding a medical teaching case to a medical teaching case database, comprising: (a) providing a medical teaching case database comprising medical teaching cases including medical case text and image information;
(b) entering medical case image and text information into a new medical teaching case; and
(c) adding the new medical teaching case to the medical teaching case database.

66. The method according to claim 65 wherein the medical teaching case database comprises a data structure representing a medical case, the data structure comprising:
(a) a first data field containing data representing image information; and
(b) a second data field containing data representing text information.

67. The method according to claim 65 wherein entering image and text information comprises entering data representing a medical image into a data field.

68. The method according to claim 65 wherein entering image and text information comprises entering data representing medical text into a plurality of data fields.

69. The method according to claim 68 wherein the data entered into at least one of the plurality of data fields represents historical information.

70. The method according to claim 68 wherein the data entered into at least one of the plurality of data fields represents educational information.

71. The method according to claim 68 wherein the data entered into at least one of the plurality of data fields represents clinical information.

72. The method according to claim 68 wherein the data entered into at least one of the plurality of data fields represents radiological information.

73. The method according to claim 68 wherein the data entered into at least one of the plurality of data fields represents classification information.

74. The method according to claim 73 wherein the classification information comprises information related to a diagnosis category.

75. The method according to claim 68 wherein the data entered into at least one of the plurality of data fields represents diagnosis information.

76. The method according to claim 68 wherein the data entered comprises information selected from the group consisting of age, location, gender, teaching, history, image year, date modified, date created, weird factor, complete, or physician and combinations thereof.

77. The method according to claim 65 further including accessing the medical teaching case database via the Internet.

78. The method according to claim 65 further including providing security information for accessing the medical teaching case database.

79. A system for adding a medical teaching case to a medical teaching case database, comprising:
(a) a memory including a medical teaching case database comprising medical teaching cases including medical case text and image information;
(b) an input operable to enter medical case image and text information into a new medical teaching case; and
(c) a database manager operable to add the new medical teaching case into the medical teaching case database.

80. The system according to claim 79 wherein the medical teaching case database comprises a data structure representing a medical case, the data structure comprising:
(a) a first data field containing data representing image information; and
(b) a second data field containing data representing text information:

81. The system according to claim 79 wherein the input is further operable to enter data representing a medical image into a data field.

82. The system according to claim 79 wherein the input is further operable to enter data representing text of the medical case into data fields.

83. The system according to claim 82 wherein the data entered into at least one of the data fields represents historical information.

84. The system according to claim 82 wherein the data entered into at least one of the data fields represents educational information.

85. The system according to claim 82 wherein the data entered into at least one of the data fields represents clinical information.

86. The system according to claim 82 wherein the data entered into at least one of the data fields represents radiological information.

87. The system according to claim 82 wherein the data entered into at least one of the data fields represents classification information.

88. The system according to claim 87 wherein the classification information comprises information related to a diagnosis category.

89. The system according to claim 82 wherein the data entered into at least one data field represents diagnosis information.

90. A computer-readable medium having stored thereon instructions for adding a medical teaching case to a medical teaching case database, comprising:
(a) providing a medical teaching case database comprising medical teaching cases including medical case text and image information;
(b) entering medical case image and text information of a medical case into a new medical teaching case; and
(c) adding the new medical teaching case into the medical teaching case database.

91. A computer-readable medium having stored thereon a data structure, comprising:
(a) a first data field containing data representing image information; and
(b) a second data field containing data representing text information.
